(19) United States
(12) Patent Application Publication
(10) Pub. No.: US 2008/0233986 A1
(43) Pub. Date: Sep. 25, 2008

(54) Transmission of Handwriting Over Sms Protocol

(76) Inventor: Y. Hazem Abdelazim, Cairo (EG)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 12/093,259

(22) PCT Filed: Nov. 10, 2006
(86) PCT No.: PCT/CA06/01836

§ 371 Date: May 9, 2008

(30) Foreign Application Priority Data
Nov. 10, 2005 (CA) 2,526,633

(51) Int. Cl. H04Q 7/20

(52) U.S. Cl. 455/466

(57) ABSTRACT

The invention provides a method of transmitting a handwriting pattern over Simple Message Service (SMS), comprising the steps of: (a) normalizing a set of points forming the handwriting pattern to produce a homogenized set of points representing the handwriting pattern; (b) compressing the homogenized set of points into a data stream; and (c) encoding the data stream for transmission using SMS.

### FIELD OF THE INVENTION

The present invention relates to the field of transmitting information using wireless communications protocols. In particular, it relates to the transmission of handwriting in Short Message Service (SMS) messages.

### BACKGROUND OF THE INVENTION

Short Message Service (SMS) is a widely used method of sending plain-text messages, most often associated with text messages sent via cellular phone. An estimated 500 billion SMS messages were sent worldwide in 2004. Use of text messaging has become sufficiently widespread that abbreviated forms of written language design to reduce input time and length for SMS messages have become popular in multiple languages.

With the vast popularity of SMS it has begun to be implemented on more sophisticated phones and devices. While a mobile phone requires the user to input a message using the standard 12-button key pad, an SMS-enabled portable digital assistant (PDA) allows the user to input a message using either an on-screen virtual keyboard or a miniaturized full function physical keyboard integrated into the PDA. While this renders messages easier to input, standard abbreviations and shorthand terms are still common.

The use of abbreviated terms is a result of the primary limitation of SMS, a fixed maximum message length. SMS messages are limited to precisely 140 bytes. In practice, this translates to either 160 7-bit characters, 140 8-bit characters, or 70 2-byte characters for languages such as Chinese, which use 2-byte UTF-16 character encoding. This does not include routing data and other metadata, which is additional to the payload size.

Content larger than the SMS 140-byte limit can be sent fragmented into multiple sequential messages (known as long SMS or concatenated SMS), in which case each message will start with a user data header containing segmentation information. The receiver is then responsible for reassembling the message and presenting it to the user as one long message. While the standard theoretically permits up to 255 segments, 3 to 4 segment messages are the practical maximum, as long messages are billed to the user as equivalent to multiple single SMS messages. As a result, long SMS sees little practical use.

The dual combination of simplicity and popularity had led to a push to develop new methods of better utilizing SMS, as well as new protocols and services to expand beyond the limitations of SMS.

One example is the development of Multimedia Messaging System (MMS) which enables transmission of multimedia content such as pictures, music, and video. MMS operates using Hypertext Transmission Protocol (HTTP) and is substantially more complex than SMS. While MMS has the potential for widespread use, issues of inter-compatibility and network overhead means that SMS is still preferred for text messages and is likely to be for some time.

Another example is Enhanced Message Service (EMS), which is an extension to allow binary documents, such as handwriting patterns and ringtones to be sent using SMS-type message protocols. However, EMS is a development by a collective of cellular phone providers and is not a universally accepted standard. Additionally, EMS is currently restricted to cellular phones and is not available on other SMS-enabled devices, such as PDAs.

Given the widespread use and simplicity of SMS, there is a need to develop a method of transmitting accurate handwriting Patterns within the limitations of SMS.

### SUMMARY OF THE INVENTION

According to an aspect of the invention there is provided a method of transmitting a handwriting (HW) pattern over Simple Message Service (SMS), comprising the steps of: (a) normalizing a set of points forming the HW pattern to produce a homogenized set of points representing the HW pattern; (b) compressing the homogenized set of points into a data stream; and (c) encoding the data stream for transmission using SMS.

Preferably, the normalization step consists of adding and removing points from the set of points such that spacing between each point in the homogenized set of points is uniform. Alternatively, the normalization step may consist of adding and removing points from the set of points such that each point in the set of homogenized points is adjacent to another point.

Preferably, the compression step uses sequential chain encoding. Alternatively, the compression step may use a Douglas-Peucker algorithm.

Preferably, the encoding step includes identifying the data stream with a binary header for a binary SMS message. Alternatively, the encoding step may include encoding the data stream using base 128 encoding. Also, the resulting encoded message may be sent by Enhanced Message Service (EMS).

The compression and encoding steps result in the HW pattern being transmitted either as a single SMS message or as a long SMS message.

According to another aspect of the present invention there is provided a method of transmitting a handwritten image over Simple Message Service (SMS), wherein the image is handwritten on a screen by a user in a series of handwriting strokes and each handwriting stroke creates a set of points, comprising: (a) normalizing each set of points forming each handwriting stroke to produce a homogenized set of points representing the handwritten image; (b) compressing all of each homogenized set of points into a single data stream; and (c) encoding the data stream for transmission using SMS.

Preferably, the steps of the method also preserve the directionality of the original handwriting strokes.

The primary advantage of the present invention is the ability to send HW patterns using the previously text-only SMS for wireless devices. Another advantage is that handwriting can be sent as an HW pattern and used for comparison purposes, such as signature verification.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a flowchart of the SMS handwriting pattern encoding process;

FIG. 2 is a handwritten message “Good Morning”;

FIG. 3 is a compass chart of direction codes for chain encoding;

FIG. 4 is a comparison of handwriting pre and post-normalization; and

FIG. 5 is a sample of a chain encoded handwriting stroke.

### DETAILED DESCRIPTION OF THE PREFERRED EMBODIMENTS

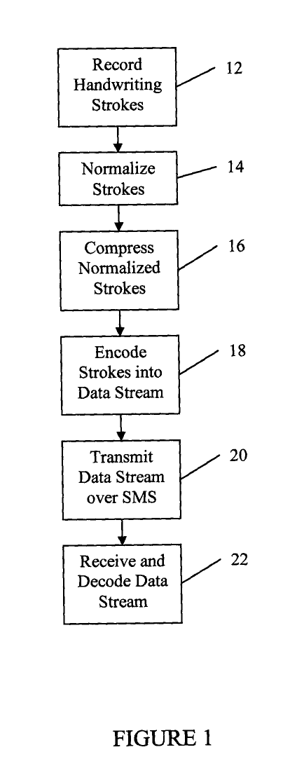

Referring now to FIG. 1, the inventive method of transmitting handwriting (referred to herein as a handwriting pattern or “HW Pattern”) over Simple Message Service (SMS) in accordance with a presently preferred embodiment is indicated generally in a flowchart.

In a standard touch screen device, such as a PDA, the user is able to “write” on the screen by moving a stylus over the surface of the screen in the same manner as moving a pen over a piece of paper. The on-screen result is a set of points which define a curve or “stroke” bounded by a “pen-down” point where the stylus initially contacts the screen, and a “pen-up” point where the stylus is removed from the screen. This “stroke” is visually identical to a stroke produced when writing with ink on paper and a person's on-screen handwriting will be generally similar to their handwriting on paper.

The first step 12 is recording the handwriting strokes that make up the HW Pattern. As a general rule this is done automatically as a user writes on the screen. However, a pre-generated or forwarded HW Pattern may need to be re-recorded or converted by the PDA software, as the original strokes are not present. Alternatively, any HW Pattern can be sent using the same method detailed below strictly on the basis of the HW Pattern data.

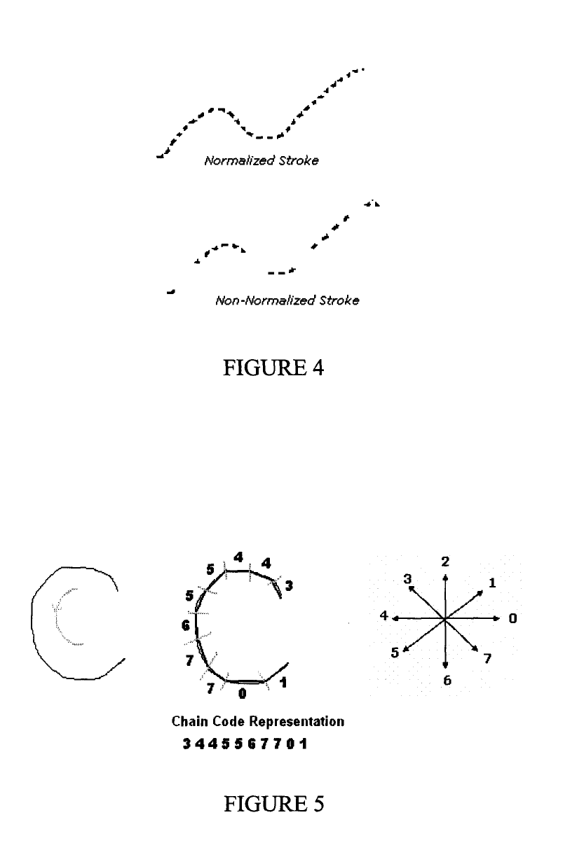

Once a stroke is recorded, it must be normalized 14. As the user completes the stroke, faster movement will result in more widely spaced points, and slower movement in more closely spaced points. Through normalization, the spacing between the points in the stroke can be homogenized as seen in FIG. 4. The result is a clearer HW Pattern, as well as enabling improved results in later compression 16 and encoding 18 steps set forth below.

Normalization 14 can be used to produce one of two results. One result is that the points that make up the stroke can be adjusted to produce a set of points with uniform spacing between each point. As a result, each point can be defined in a direction and a fixed distance from the previous point. This result becomes important when considering the next step, compression.

An alternative result is that the points that make up the stroke are adjusted such that each point is adjacent to another point. As a result, each point can be defined in a direction from the previous adjacent point. However, spacing is not uniform as diagonally adjacent points are separated by a greater distance than horizontally or vertically adjacent points.

The difference between the two normalization methods lies in message size and HW Pattern fidelity. Uniform spacing allows fewer points to be used to reconstruct the original HW Pattern, therefore less data must be sent in the message. However, some of the fidelity of the original HW Pattern may be lost from dropped points. Adjacent point normalization results in an HW Pattern with greater fidelity, but also a larger amount of data to send. Ideally, the user is provided with an option to choose the method of normalization to control the desired HW Pattern fidelity and message size.

A further reduction in the data requirements for the HW Pattern may be achieved by using another reduction algorithm, such as a Douglas-Peucker algorithm to reduce the number of points in the HW Pattern. While some of the fidelity of the original HW Pattern is lost, the reduction in the number of data points for a complex curve may be necessary to reduce the number of points sufficiently for HW Pattern transmission with fewer SMS messages. Ideally, enabling additional algorithms should be provided as an option for the user.

When an alternative algorithm such as a Douglas-Peucker is used, the result is a series of significant anchor points. Only these anchor points may be transmitted, and there is no need for further normalization on the sending side. On the receiving side, when these points are received, they need to be connected with straight lines (or, alternatively, more complex connections such as Bezier/B-Spline Curves). Then, to connect the points to form straight lines, the anchor points are re-normalized with adjacent points as discussed above.

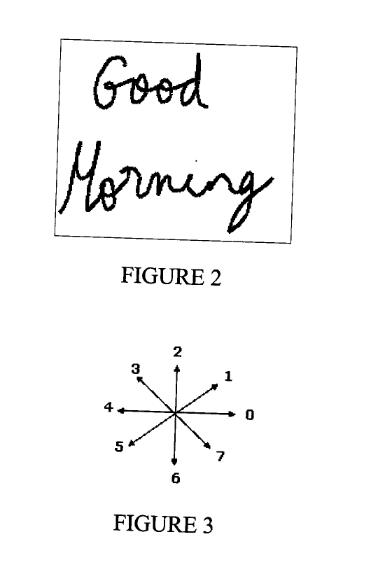

Once the stroke is normalized 14, the data for the stroke (i.e. set of points) must be prepared for sending. In the HW Pattern shown in FIG. 2, the original handwritten phrase “Good Morning” contains 417 points. If each point is described according to its (x,y) co-ordinates onscreen, each point requires 4 bytes of information for identification (2 integers x and y, with 2 bytes required for each integer). For 417 points, the resulting message size is 1668 bytes. As SMS is limited to 140 bytes per message, it would require a long SMS message equivalent to 12 SMS messages to send the HW Pattern. This result defeats the purpose of using SMS for simplicity and cost reduction. Even after normalization, the byte requirements for the number of points in the HW Pattern as pixel co-ordinates would still exceed the byte limit of a single SMS message and require a generally unreasonable amount of equivalent SMS messages to send via long SMS.

Therefore, some means of compression 16 must be used to reduce the message size. One way is to use sequential chain coding. In chain coding, each potential direction is assigned a direction code from 0-7 as shown in FIG. 3. For each point, the identity of the next point is determined by a direction code. Each stroke can thus be represented as a sequential string of direction codes starting from the pen-down point and ending at the pen-up point as seen in the example curve in FIG. 5.

As the direction codes range from 0-7, each can be described by 3 bits (8 bits=1 byte). For the original 417 points in our example in FIG. 2, the sequential chain code is 417×3=1251 bits or 156 bytes (rounded up to the next highest multiple of 8). This number still exceeds the 140-byte limit for a single SMS message, however, illustrating the need to utilize one of the above normalization methods to reduce the number of points and therefore the number of bytes if one needs to send the HW Pattern as a single SMS message. For a single 140-byte SMS message, the maximum number of chain coded points that can be sent is 373 (373×3=1119 bits, 140 bytes is 1120 bits). Of course, the larger HW Pattern can be sent in long SMS format, if required or if the user desires. Notably, the required long SMS message is now equivalent to 2 SMS messages, as opposed to the 12 required to sent the original HW Pattern as (x,y) pixel data. Again, the ability to transmit as long SMS and avoid some of the normalization and compression steps should be provided as a user option. However, for the most effective use of chain coding, the points should be normalized to keep the size of a long SMS message to a minimum.

Two separate methods of chain coding compression are considered depending on the method of normalization. If the set of points was normalized with uniform spacing, then in addition to the direction codes, an indication of the spacing value between points must also be provided. If adjacent point normalization was used, then the chain coded direction codes themselves are sufficient to permit reconstruction of the HW Pattern. Once the HW Pattern has been compressed it can be sent to a receiver.

Another advantage of chain coding is that the directionality of the original writing can be preserved. By using a pen-down position as the start of the chain, and following the chain to the corresponding pen-up point, the data for the resulting stroke reflects the stroke as input by the user on-screen. The preservation of directionality is useful for handwriting analysis, particularly signature verification, and also provides a personalized visual display of the handwriting movement of the sender when recreated at the receiving end.

Sending the normalized, compressed HW Pattern via SMS to a receiver may require a further encoding step 18. As SMS protocol is based on transmitting text messages, there is a limit of 128 different characters that can be sent (ASCII standard set) such that only 7 bits per byte are required to describe each character (byte values 0-127). In a standard SMS message, any bytes with decimal values greater than 127 are ignored.

While SMS specifications allow for a message to be sent with a binary header, meaning that byte values greater than 127 will be acknowledged, not all devices are compatibility with binary header format. Therefore, for maximum compatibility, the bytes containing the chain coded HW Pattern information must be modified to have values of 127 or less. This can be done using base 128 encoding.

In base 128 encoding, the chain direction codes are combined into a single binary stream. Next, this binary stream is segmented at every 7 bits to get a byte with a value less than 128. These bytes are then sent by SMS and the single binary stream is reconstructed at the receiving end from the individual bytes. In this way, the non-text bytes for the chain direction codes can be sent just like text i.e. SMS has no way of separately identifying a text message from an HW Pattern message. This encoding allows the HW Pattern transmission to be compatible with any hardware that supports SMS.

Once the message is encoded 18 it is transmitted 20 using SMS. The transmitted SMS message is then decoded and displayed 22 on the receiver's screen. The receiver may be provided with an option to keep the encoded version of the image HW Pattern, so that the HW Pattern can be forwarded or duplicated to another user without repeating the full HW Pattern encoding process. Alternatively, for other types of messages, such as signature verification, the encoding may be destroyed in the process of recreating the HW Pattern, prevent unauthorized duplication.

While this description has used a handwritten message as an example, it can be readily seen that any HW Pattern, hand-drawn or otherwise can be sent in this manner.

While this description has indicated the method is designed primarily for SMS messages, Enhanced Message Service (EMS) messages could also theoretically be used. Depending on the EMS standard and compatibility, it may not be necessary to use 128-bit encoding as EMS theoretically identifies binary headers.

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

What is claimed is:

1. A method of transmitting a handwriting (HW) pattern, comprising:
(a) normalizing a set of points forming said HW pattern to produce a homogenized set of points representing said HW pattern;
(b) compressing said homogenized set of points into a data stream; and
(c) encoding said data stream such that said data stream can be transmitted using Simple Message Service (SMS).

2. The method according to claim 1, wherein said normalization step consists of adding and removing points from said set of points such that spacing between each point in said homogenized set of points is uniform.

3. The method according to claim 1, wherein said normalization step consists of adding and removing points from said set of points such that each point in said set of homogenized points is adjacent to another point.

4. The method according to claim 1, wherein said compression step uses sequential chain encoding.

5. The method according to claim 1, wherein a Douglas-Peucker algorithm is used to eliminate points from said set of points prior to said normalization step or said compression step.

6. The method according to claim 1, wherein said encoding step includes identifying said data stream with a binary header for a binary SMS message.

7. The method according to claim 1, wherein said encoding step includes encoding said data stream using base 128 encoding.

8. The method according to claim 1, wherein said compression and encoding steps result in said HW pattern being transmitted in a single SMS message.

9. The method according to claim 1, wherein said compression and encoding steps result in said HW Pattern being transmitted as a long SMS message.

10. The method according to claim 1, wherein said compression and encoding steps also allow said HW pattern to be transmitted as an Enhanced Message Service (EMS) message.

11. A method of transmitting a handwritten image over Simple Message Service (SMS), wherein said image is handwritten on a screen by a user in a series of handwriting strokes and each handwriting stroke by said user creates a set of points, comprising:
(a) normalizing each said set of points forming said each handwriting stroke to produce a homogenized set of points representing said handwritten image;
(b) compressing all of each said homogenized set of points into a single data stream; and
(c) encoding said data stream such that said data stream can be transmitted using SMS.

12. The method according to claim 11, wherein said steps (a) to (c) preserve directionality for each said handwriting stroke.
